(19) United States
(12) Patent Application Publication
(10) Pub. No.: US 2016/0247587 A1
(43) Pub. Date: Aug. 25, 2016

(54) Liquid metal cooled nuclear reactor, system for monitoring oxygen thermodynamic activity in such reactors and method of monitoring oxygen thermodynamic activity

(71) Applicant: Joint Stock Company "AKME-Engineering", Moscow (RU)

(72) Inventors: Radomir Shamilievich Askhadullin, OBNINSK (RU); Konstantin Dmitrievich Ivanov, OBNINSK (RU); Petr Nikiforovich Martynov, OBNINSK (RU); Aleksey Nikolaevich Storozhenko, OBNINSK (RU)

(21) Appl. No.: 15/021,697

(22) PCT Filed: May 8, 2014
(86) PCT No.: PCT/RU2014/000331

§ 371 Date: Mar. 13, 2016

(30) Foreign Application Priority Data
Nov. 12, 2013 (RU) 2013150258

(51) Int. Cl. G21C 17/025; G21C 15/247

(52) U.S. Cl. CPC G21C 17/025; G21C 15/247; G21Y 2002/103; G21Y 2004/30

(57) ABSTRACT

The invention relates to nuclear power engineering and can be used in power plants with lead-containing liquid metal coolants, and particularly in fast neutron reactors. The proposed nuclear reactor and the method and system for monitoring the thermodynamic activity of oxygen in a coolant with continuously operational oxygen thermodynamic activity sensors located in the “hot” and “cold” zones of the reactor vessel and an additional intermittently operational sensor make it possible to carry out continuous monitoring in order to maintain set oxygen thermodynamic activity values in a liquid metal coolant under any prescribed operating regime.

### FIELD OF THE INVENTION

The invention relates to nuclear power, and can be used in power plants with lead-containing liquid metal coolants, in particular in fast-neutron reactors with a heavy liquid metal coolant (HLMC), eutectic alloy 44.5% Pb-55.5% Bi and lead, respectively, in the primary circuit.

The distinctive feature of HLMC is its rather high corrosiveness with respect to structural materials.

In this connection, the main purposes of lead-containing liquid metal coolant technology arising during their use are as follows:
ensuring corrosion resistance of the structural materials used in contact with the lead-containing liquid metal coolant;
providing the required purity of both the coolant and internal surfaces of the circulating loop equipment (to avoid slagging of individual sections of the plant).

Concentration of oxygen dissolved in the HLMC affects the corrosion behavior of surfaces of the equipment and pipelines operating in contact with the HLMC significantly.

Due to the lower affinity of lead and bismuth for oxygen as compared to iron and chromium, rather thin (1-10 μm) dense oxide films with good adhesion to the substrate form on steel surfaces in contact with lead or lead-bismuth melts containing dissolved oxygen. When such films are present, corrosion resistance of structural materials increases greatly.

Therefore, currently, the main method for protection of structural materials in contact with the HLMC is oxygen passivation (inhibition) of surfaces, which consists in the forming and maintaining of oxide films on the material surfaces.

Due to the oxide nature of the films, their state during plant operation is largely determined by the level of thermodynamic activity of oxygen in the coolant.

When the concentration of dissolved oxygen in the coolant (lead-bismuth, lead) falls below the critical value, reliable corrosion protection of structural steel is not provided.

On the other hand, a significant amount of oxygen in the coolant is undesirable as it can lead to unacceptable accumulation of solid-phase oxides in the coolant.

All this requires continuous monitoring of maintenance of the set thermodynamic activity of oxygen in the coolant in all design modes of operation.

### PRIOR ART

A nuclear power plant is known comprising a nuclear reactor with a liquid metal coolant, with the core below the coolant level, steam generators, circulation pumps and a system of liquid metal coolant state monitoring by regular measurements of thermodynamic activity of oxygen with a single control element immersed in the coolant and connected to the measuring unit in the vessel. [P. N. Martynov, R. Sh. Askhadullin, A. A. Simakov et al. Development of an Automated System of Monitoring, Forecasting and Control of the State of the Lead-Bismuth (Lead) Coolant and Surfaces of the Nuclear Power Plant Circuit, proceedings of the third interdisciplinary scientific and practical conference “Heavy Liquid Metal Coolants in Nuclear Technologies.” Obninsk. Sep. 15-19, 2008, 2 volumes. Obninsk: RF SSC-IPPE, 2010. V. 1. PP. 128-136]).

However, these findings are not always objective, since they not provide no true values of oxygen thermodynamic activity in various parts of the circuit under various process conditions, which leads to slagging and oxide phase crystallization in the “cold” parts of the nuclear plant circuit parts, and to destruction of protective oxide coatings on the inner surfaces of structural materials in its “hot” sections.

Therefore, for reliable and safe operation of nuclear plants with a circulating liquid metal coolant, it is necessary to maintain the thermodynamic activity of oxygen in the coolant at a certain level, and thus to provide reliable and accurate monitoring of this parameter.

In addition, it is common practice to obtain timely information on thermodynamic activity of oxygen as a function of temperature by changing the mode of operation of the entire nuclear plant (change of its power, coolant flow rate), which is extremely undesirable.

### INVENTION DISCLOSURE

The technical purpose of this invention is to ensure reliable monitoring of the set thermodynamic activity of oxygen in the liquid metal coolant and maintain the same under any design operating conditions of the nuclear plant.

The technical result of the invention is increased reliability of reactor operation due to the possibility to obtain continuous and reliable information on physical and chemical processes in the liquid metal coolant in the reactor flow path.

The above result is achieved by creation of a nuclear reactor with a liquid metal coolant comprising a vessel with the core below the coolant level, steam generators, circulating pumps and a liquid metal coolant state monitoring system containing a control element located in the reactor and connected to the measuring unit, wherein the system control element includes oxygen thermodynamic activity sensors located in the center and periphery of the reactor pressure vessel, with sensing elements in the liquid metal coolant layer, and an additional oxygen thermodynamic activity sensor located above the liquid metal coolant level designed so as to allow its periodic immersion into the coolant.

The number of oxygen thermodynamic activity sensors may vary; the increase in their number increases the measurement accuracy. However, their installation is associated with impaired integrity of the reactor vessel, therefore, it is preferable to install at least two oxygen thermodynamic activity sensors whose sensing elements are in the liquid metal coolant layer. One of them is in the “hot” central part of the reactor vessel where the coolant exits the core, and the second one is in the “cold” peripheral part of the vessel.

As an additional oxygen thermodynamic activity sensor located above the coolant level operates intermittently, it is equipped with a vertical movement device for immersion of the sensing element of this sensor in the coolant layer.

It is preferable that the additional oxygen thermodynamic activity sensor shall be located above the coolant level in the reactor vessel central part.

Preferably, solid-state electrolytes are used as oxygen thermodynamic activity sensors.

The technical result of the invention is achieved by creation of a nuclear reactor liquid metal coolant state monitoring system containing a control element located in the reactor connected to a measuring unit, wherein the control element includes oxygen thermodynamic activity sensors located in the center and periphery of the reactor pressure vessel, with sensing elements in the liquid metal coolant layer, and an additional oxygen thermodynamic activity sensor located above the liquid metal coolant level designed so as to allow its periodic immersion into the coolant.

It is preferable to install at least two oxygen thermodynamic activity sensors whose sensing elements are in the liquid metal coolant layer.

It is preferable that the additional oxygen thermodynamic sensor located above the coolant level is equipped with a vertical movement device.

It is also preferable that the additional oxygen thermodynamic activity sensor shall be located above the coolant level in the reactor vessel central part.

Preferably, solid-state electrolytes are used as oxygen thermodynamic activity sensors.

The sensors shall operate reliably under conditions of aggressive impact of Pb or Pb—Bi melt at 350-650° C., under pressures of up to 1.5 MPa, thermal shocks of up to 100° C./sec, and at coolant rates of up to 1.0 m/sec.

Therefore, the operation of oxygen thermodynamic activity sensors used in the invention is based on the electrochemical method with a galvanic concentration cell based on solid oxide electrolyte. Such sensors are known and applied to determine the oxygen content in various substances in the field of power engineering, to monitor oxygen in gases in the chemical and automotive industries; and to monitor oxygen in metal melts in metallurgy and semiconductor technology.

The applicant also defends a method for monitoring of oxygen thermodynamic activity in a nuclear reactor with a liquid metal coolant according to claim 1 by means of measurement of oxygen thermodynamic activity in the coolant and transfer of readings to the measurement unit, wherein measurements are performed continuously in the “hot” central part and “cold” peripheral part of the reactor vessel and oxygen thermodynamic activity is additionally measured in the “hot” central part of the reactor on an intermittent basis.

Additional measurements of oxygen thermodynamic activity are performed in the central part of the reactor 1 or 2 times a month.

### BRIEF DESCRIPTION OF THE DRAWINGS

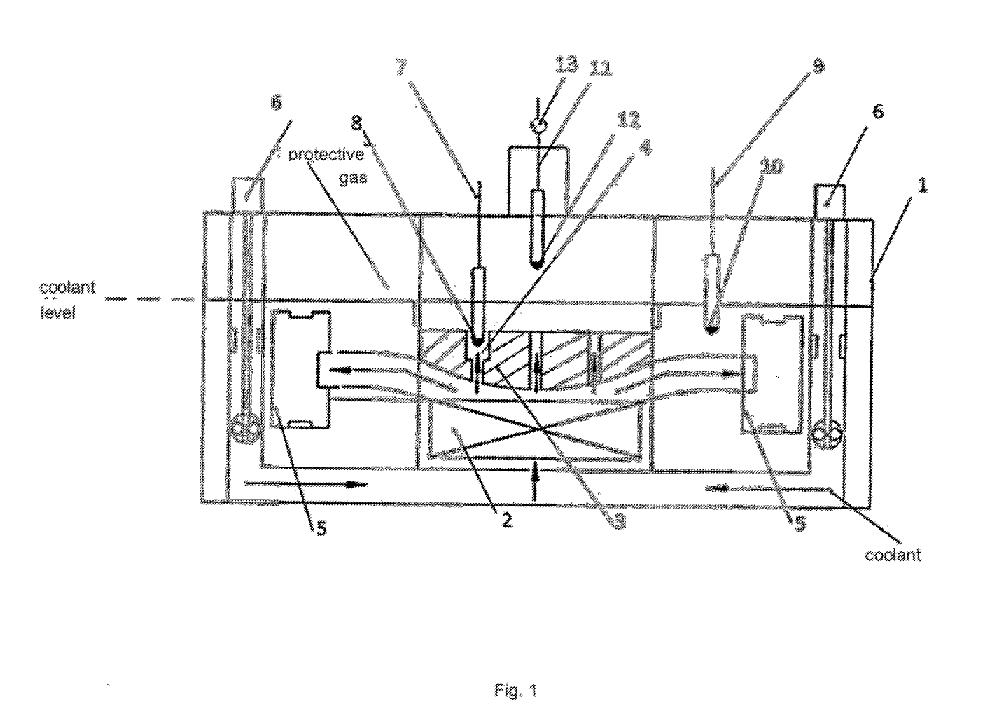

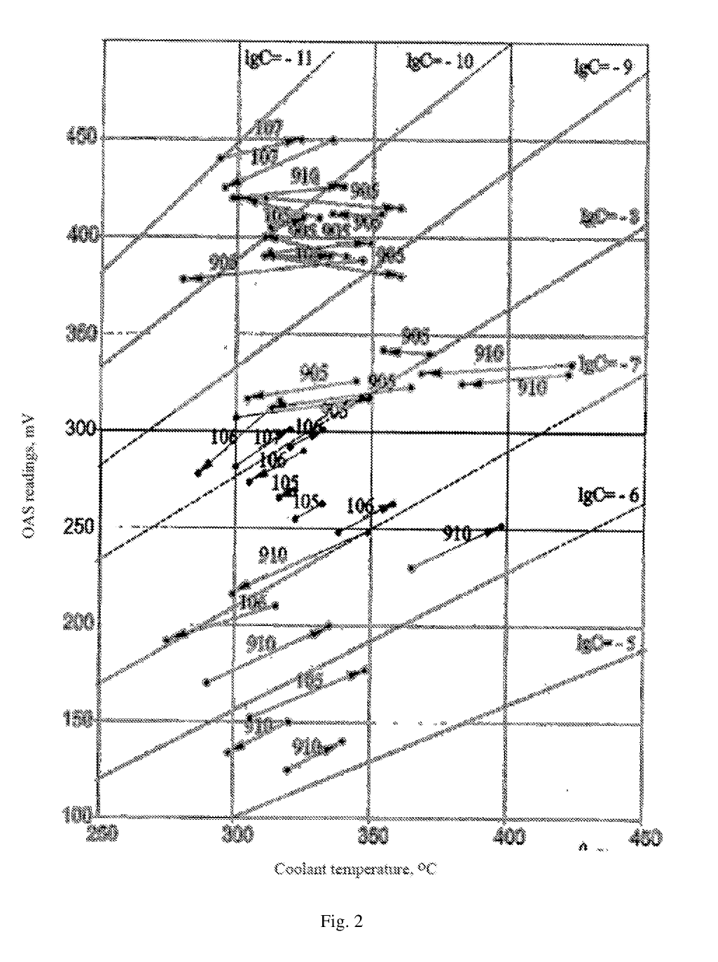

The invention is illustrated by drawings, where FIG. 1 shows a nuclear reactor with a system for monitoring of oxygen thermodynamic activity in the liquid metal coolant, and FIG. 2 is a graph showing the dependence of readings of oxygen thermodynamic activity sensors (OAS) on the lead-bismuth coolant temperature in BM-40A and OK-550 plants.

### IMPLEMENTATION OF THE INVENTION

The nuclear reactor with a liquid metal coolant has a vessel 1 with the core 2 under the coolant level, a shielding plug 3 with a sensor channel 4 is located above the core. The reactor vessel 1 also contains steam generators 5 and circulating pumps 6; protective gas is located in its upper part.

The system for monitoring of oxygen thermodynamic activity in the coolant comprises a permanent oxygen thermodynamic activity sensor 7 equipped with a sensing element 8 located in the liquid metal coolant layer in the “hot” central part of the reactor vessel 1, in the channel 4 of the shielding plug 3. The sensor 7 is connected to the common measuring unit (omitted in the drawing).

The oxygen thermodynamic activity sensor 9 of the monitoring system has a sensing element 10 located in the liquid metal coolant layer in the “cold” peripheral part of the reactor vessel 1. The sensor 9 is connected to the common measuring unit (omitted in the drawing).

An additional oxygen thermodynamic activity sensor 11 of the monitoring system is located above the liquid metal coolant level and designed so as to allow periodical movement of its sensing element 12 below the coolant level using a vertical movement device 13 of any design suitable for the purpose. The sensor 11 is also connected to the common measuring unit (omitted in the drawing).

Frequency of measurement of oxygen thermodynamic activity by the additional sensor 11 is determined experimentally on a case-by-case basis, and is twice a month at average.

The nuclear reactor with an oxygen thermodynamic activity monitoring system operates, and a monitoring method is performed as follows:

A molten coolant heated in the core 3 is supplied under pressure created by the pumps 6 to the steam generators 5 and transfers heat of the core to water vapor. During reactor operation, numeric values of oxygen thermodynamic activity in the “hot” and “cold” areas of the reactor vessel 1 are determined using the oxygen thermodynamic activity sensors 7 and 9. Measurements are transmitted to the single measuring unit. Then the temperature dependence of the oxygen thermodynamic activity is determined and compared with its tabulated values, which allows to draw a conclusion on the state of the liquid metal coolant, for example, on the presence of impurities in the coolant as a result of interaction with structural steel.

If the measured parameters deviate from the set values, the concentration of oxygen dissolved in the coolant is maintained by dissolution of coolant component oxides that are preliminarily supplied into the circuit or formed by crystallization from the coolant and accumulation on the filter.

Thus, continuous monitoring of maintenance of the set thermodynamic activity of oxygen in the coolant in all design modes of operation is performed.

As already noted above, during operation of the plant, the oxygen thermodynamic activity in the coolant should be within the range that, on the one hand, preserves the oxide passivation films on structural material surfaces, i. e. their corrosion resistance, and, on the other hand, prevents slag deposits on the inner surfaces of the reactor circuit elements in all parts of the non-isothermal circuit.

During long-term operation of nuclear reactors with a circulating circuit with a liquid metal coolant, the oxygen dissolved in the coolant is continuously consumed for binding of structural material component impurities diffusing into the melt (iron, chromium) having a greater oxygen affinity as compared to the coolant components.

This can lead to reduction of the dissolved oxygen concentration to a value when protective oxide coatings begin to degrade, which means a sharp increase in corrosion. Therefore, one of the most important parameters describing the quality of operation of circulating circuits with lead-based liquid metal coolants is the thermodynamic activity of oxygen dissolved in the melt to be monitored continuously.

According to this invention, in the event of failure or suspected failure of permanent sensors, measurements are performed by the oxygen thermodynamic activity sensor 11 (with the monitoring and backup functions). Measurements are performed intermittently, for instance, 1 to 2 times a month, in order to compare them with the readings of the sensors 7 and 9, or to be able to measure oxygen thermodynamic activity when they fail.

Thus, the increased reliability of nuclear reactor operation and accuracy of the obtained information on physical and chemical processes in its flow path are increased. Installation of permanent oxygen thermodynamic activity sensors in the “hot” and “cold” parts of the reactor pressure vessel and availability of an additional oxygen thermodynamic activity sensor of intermittent operation also allow to obtain real-time data without the common practice of reactor operation mode change.

Application of this invention allows to extend the service life of the nuclear reactor steel circulating circuit with a liquid metal coolant, eliminate slag deposits and improve efficiency of the filter units applied in the circuits.

The graph showing the dependence of readings of the oxygen thermodynamic activity sensors (OAS) on the temperature of the lead-bismuth coolant in FIG. 2 demonstrates specific readings of sensors of oxygen thermodynamic activity in lead-bismuth circulation circuits of different nuclear plants as an illustration to the invention description.

1-12. (canceled)

13. A nuclear reactor with a liquid metal coolant, comprising:
a vessel with a core below the liquid metal coolant level;
steam generators;
circulating pumps; and
a liquid metal coolant state monitoring system containing a control element located in the reactor and connected to a measuring unit;
wherein the system control element includes oxygen thermodynamic activity sensors located in a center portion and a periphery of a reactor pressure vessel, with sensing elements in a layer of the liquid metal coolant, wherein an additional oxygen thermodynamic activity sensor is located above the liquid metal coolant level and configured so as to allow periodic immersion into the liquid metal coolant.

14. The reactor according to claim 13, wherein at least two oxygen thermodynamic activity sensors whose sensing elements are in the liquid metal coolant layer are installed.

15. The reactor according to claim 13, wherein the additional oxygen thermodynamic sensor located above the liquid metal coolant level is equipped with a vertical movement device.

16. The reactor according to claim 13, wherein the additional oxygen thermodynamic sensor is located in the center portion of the reactor vessel.

17. The reactor according to claim 13, wherein solid-state electrolytes are used as the oxygen thermodynamic activity sensors.

18. A nuclear reactor liquid metal coolant state monitoring system, comprising:
a control element located in the reactor and connected to a measuring unit;
wherein the control element includes oxygen thermodynamic activity sensors located in a center portion and a periphery of the reactor pressure vessel;
sensing elements located in the liquid metal coolant layer; and
an additional oxygen thermodynamic activity sensor located above a level of the liquid metal coolant and configured so as to allow periodic immersion into the liquid metal coolant.

19. The system according to claim 18, wherein at least two oxygen thermodynamic activity sensors whose sensing elements are in the liquid metal coolant layer are installed.

20. The system according to claim 18, wherein the additional oxygen thermodynamic sensor located above the liquid metal coolant level is equipped with a vertical movement device.

21. The system according to claim 18, wherein the additional oxygen thermodynamic sensor is located in the center portion of the reactor vessel.

22. The system according to claim 18, wherein solid-state electrolytes are used as the oxygen thermodynamic activity sensors.

23. A method for monitoring of oxygen thermodynamic activity in a nuclear reactor, comprising the steps of:
providing a nuclear reactor with a liquid metal coolant, comprising:
a vessel with a core below the liquid metal coolant level;
steam generators;
circulating pumps; and
a liquid metal coolant state monitoring system containing a control element located in the reactor and connected to a measuring unit;
wherein the system control element includes oxygen thermodynamic activity sensors located in a center portion and a peripheral portion of a reactor pressure vessel, with sensing elements in a layer of the liquid metal coolant, wherein an additional oxygen thermodynamic activity sensor is located above the liquid metal coolant level and configured so as to allow periodic immersion into the liquid metal coolant;
measuring the oxygen thermodynamic activity in the liquid metal coolant and transferring readings of the measurements to the measurement unit;
wherein the measurements are performed continuously in the center portion and the peripheral portion of the reactor vessel and oxygen thermodynamic activity is additionally measured in the center portion of the reactor on an intermittent basis.

24. The method according to claim 23, wherein additional measurements of oxygen thermodynamic activity are performed in the center portion of the reactor 1 or 2 times a month.
